(19) United States
(12) Patent Application Publication
(10) Pub. No.: US 2005/0102317 A1
(43) Pub. Date: May 12, 2005

(54) System and method for event calendaring using a customizable rules subset

(76) Inventor: Ali Kamarei, Palo Alto, CA (US)

Correspondence Address: Ali Kamarei, Esq., 280 Colorado Avenue, Palo Alto, CA, 94301, US

(21) Appl. No.: 10/993,818

(22) Filed: Nov. 19, 2004

Related U.S. Application Data
(63) Continuation-in-part of application No. 09/621,156, filed on Jul. 21, 2000, now Pat. No. 6,387,818.
(63) Continuation-in-part of application No. 09/621,155, filed on Jul. 21, 2000, now Pat. No. 6,859,806.

(51) Int. Cl. G06F 17/00

(52) U.S. Cl. 707/102

(57) ABSTRACT

The invention described is a computer based method for event calendaring using an electronic customizable client rules subset. The method of the invention comprises of the following steps. Under control of a client system, a calendaring request message is sent to a host server system that is identified by a first uniform resource locator (URL), the host server system having a client case listing database containing case information from at least two client systems. The calendaring request message further comprises pattern data and a pattern data date. Under control of the host server system, it receives the calendaring request message, identifies the client system using a client system identifier, identifies the customizable client rules subset in a rule module database associated with the identified client system, and using the pattern data contained in the calendaring request message selects at least one associated action prompt from the customizable client rules subset. Once the action prompt is selected, the host server system computes an action prompt due date for each of the associated action prompts using the pattern data date and a time calculus. The action prompt and the computed action prompt due date are recorded in the client system case listing database for the case selected by the client system.

### CROSS-REFERENCE

This is a continuation-in-part of U.S. patent application No. 09/621,155; filed Jul. 7, 2000; now issued as U.S. Pat. No. ______.

### FIELD

The invention relates generally to computer systems designed to execute electronic professional calendaring on behalf of users. More specifically, this invention relates to real-time, on-line computer based systems, which use the Internet to enable event calendaring using a host server system, wherein professionals are able to create event calendaring rules for their business.

### BACKGROUND

Generally, whenever a professional accepts work or a client, the professional issues a case number, client number, or work order number and creates a case. During the pending of the case, which is generally measured from the time the case is initiated until when the case is terminated, certain actions must be undertaken by the parties involved with the case within a certain time period. Occasionally, certain actions must be undertaken by a governmental entity within a certain time period that generally needs to be tracked by the parties involved in the case. If the parties do not undertake the required or requested actions within the specified period of time, a client or a legal right may be lost.

Often, these professionals that include dentists, physicians, accountants, and teachers, have multiple cases with various tasks or actions that need to be accomplished by a certain due date.

Naturally, whenever the number of cases handled by professionals increases, it becomes more difficult to manage them. These actions have dates that are sometimes months if not years into the future. With the increase in cases and actions, the management of these cases requires additional attention.

Event calendaring is the process by which professionals, their assistants, or clients, track the progress of a case along with receiving and obtaining reminders. Calendaring can be either done manually, by entering actions and their due dates onto a paper calendar, or done electronically by employing software that keeps track of actions and their due dates using electronic databases.

The importance of calendaring is central to professionals, as is the tracking of appointments or events for a case. A mistake in calendaring, or the inaccessibility of calendaring data, appointments, and their due dates, can result in serious damage to a client's case and that in turn can have serious consequences for the professional who has responsibility for the client in that case.

Handwritten entries onto paper calendars provided parties with means of reminding them of appointments in a case, however, in response to the pressures stated above, electronic calendaring technologies have become more prevalent. While advances in electronic calendaring have been significant in aiding parties in keeping track of their cases, many of the issues surrounding accuracy in calendaring has been ignored. In particular, a significant source of error in electronic calendaring is the manual entry and re-entry of data into electronic systems for events that require multiple reminders, by multiple parties.

For example, in a dental office, when the patient has multiple appointments given to him, each date has to be manually entered on each day scheduled for the patients' visits to the office. In addition to the each appointment date, individual reminders for those appointments also have to be manually entered.

The problem with manual entry of multiple dates is that it increases the probability of erroneously entries, potentially resulting in the patient being reminded for the wrong appointment date, or not being reminded at all.

Additionally, the cost of operating and maintaining electronic databases is significantly high to users. These electronic systems require individuals that are highly trained in their profession as well as system administration such as management of databases and backups.

The problem with the current electronic calendaring systems is understood better if for example one considers the procedures in a financial accounting firm. Due to the recent Sarbanes-Oxley Act of 2002, financial accounting firms have been required by sections 302 and 404 to specifically certify the accuracy of financial statements and disclosures, submit periodic reports specifying any significant changes in internal controls or related factors and disclose all deficiencies in the design or operation of internal controls. Also, the financial accounting firms are required to provide auditor's attestation to, and report on, management's assessment of the internal controls and procedures for financial reporting. The above stated regulations are required to be provided within every 90 (quarterly) days. As a result of the Act, firms will be spending a significant time and money to ensure complete compliance. In order to properly comply with the Act's regulations, a close watch on dates must be implemented. Failure to comply with these regulations will result in forced public disclosures, therefore effecting the firm's reputation and value in the marketplace. With the government paying closer attention to the financial accounting firms, an error in date entry will result in a tremendous increase of cost in management. The current electronic calendaring systems do not address the problems associated with event calendaring especially in regards to manual re-entry of substantially identical information, into different dates.

Also, some professions have undertaken to use electronic and redundant calendaring systems, which has increased the cost of managing them. For others, the cost of electronic and redundant calendaring is prohibitive as these “standalone” systems require installation, hardware requirements, office networking, database maintenance, software upgrades, conversion of data from the old database to the new database after software upgrades, and legal rules updates, which has left many legal practitioners without the use and benefit of appropriate case management systems.

In view of the foregoing, there is a significant need for a computer based centrally managed event calendaring system that reduces manual re-entry of data to reduce the possibility of calendaring errors.

There is an additional need for an intelligent calendaring system that automatically calendars specific actions only on one or more dates from entry of other data. For example, when a surgery date is inputted, the pre-medication date is also calendared.

There is also a need for a calendaring system that enables the user to access and edit their data regardless of their physical location.

Further, there is a need for a computer calendaring system that provides users with centralized storage, access, and editing of their electronic data via the Internet.

There is also a need for a computerized calendaring system wherein the user can customize the type of reminders, quantity of reminders, and time of reminders. Additionally, there is a need for a professional calendaring system that can provide reminders to parties in various forms including facsimile and electronic mail message (“e-mail”).

Lastly, such a system must be affordable and reduce the cost in maintaining databases, maintaining back up of databases, updating rules and requirements tailored to particular professions, and upgrading software without data conversion.

### SUMMARY

The invention described is a computer based method for event calendaring using an electronic customizable client rules subset. In an embodiment, the method of the invention comprises of the following steps. Under control of a client system, a calendaring request message is sent to a host server system that is identified by a first uniform resource locator (URL), the host server system having a client case listing database containing case information from at least one client system. The calendaring request message further comprises of a pattern data and a pattern data date. Under control of the host server system, it receives the calendaring request message, identifies the client system using a client system identifier, identifies the customizable client rules subset in a rule module database associated with the identified client system, and using the pattern data contained in the calendaring request message selects at least one associated action prompt from the customizable client rules subset. Once the action prompt is selected, the host server system computes an action prompt due date for each of the associated action prompts using the pattern data date and a time calculus. The action prompt and the computed action prompt due date are recorded in the client system case listing database for the case selected by the client system.

In an embodiment, the computer based system for event calendaring using an electronic customizable client rules subset, comprises of at least two client systems, each client system identified by a unique uniform resource locator. The host server system which is identified by a uniform resource locator further comprises of at least two customizable client rules subsets from at least two client systems, the client rules subset further comprising pattern data, and at least one action prompt associated with the pattern data, an Identicator for identifying the client system and the client rules subset, and a client case listing database containing case information from at least two client systems.

The advantages of the described calendaring system are that it reduces manual re-entry of data to reduce the possibility of calendaring errors.

Another advantage is that the calendaring system enables users to access and edit their action prompts, action prompt due dates, and data, regardless of their physical location.

Yet another advantage of the computer based calendaring system is that the user can customize the type of action prompts, quantity of action prompts, and time of action prompts.

Lastly, such a system is affordable and reduces the cost of calendaring in maintaining databases, maintaining back up of databases, updating rules and requirements tailored to particular professional practices, and upgrading software without data conversion.

These and other advantages of the invention will become more fully apparent when the following detailed description of the invention is read in conjunction with the accompanying drawings.

### BRIEF DESCRIPTION OF DRAWINGS

FIG. 1 shows an embodiment of the invention having, a rules module database, a case listing database and an Identicator module.

FIG. 2 shows a preferred embodiment of the invention having automated calendaring and filing modules for interactions between the Host Server System and Third-Party Authorized Systems.

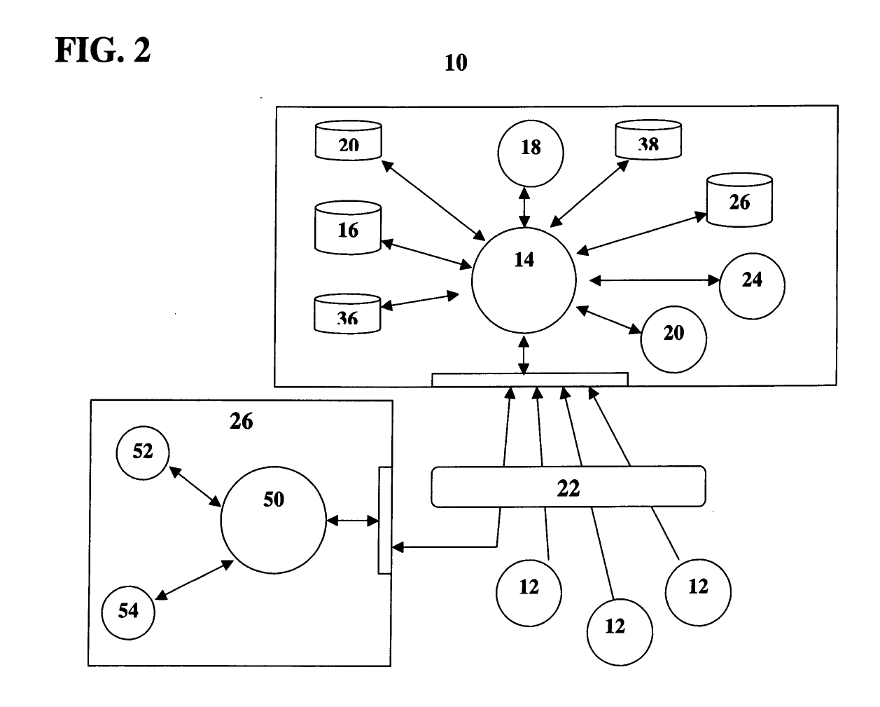

FIG. 3 shows a graphic representation of a rule module database having client rules subsets and its components and the relationship between action prompts and data patterns.

FIG. 4 shows a flow chart preferred embodiment of calendaring using the customizable client rules subset.

FIG. 5 shows a flow chart of the preferred embodiment of automated calendaring for a client system through interfacing with Third-Party entities.

FIG. 6 shows a graphic interface screen of the calendaring system of the invention with default action prompts.

FIG. 7 shows a graphic interface screen of the calendaring system of the invention with customizable action prompts, time calculus, and action prompt delivery type.

FIG. 8 shows a graphic interface screen of the calendaring system of the invention with multiple action prompts associated with and triggered from pattern data.

### DETAILED DESCRIPTION

This invention provides a real-time computer based on-line method and system for professional calendaring between a Host Server System 10 and at least one Client Systems 12. Electronic transmissions between the Host Server System and Client System occur over the Internet 22. In preferred embodiments, the Host Server System communicates with Third-Party Systems such as an Authorized System 26 via the Internet 22. Examples of an Authorized System are a representative of a Client System such as the professional's lawyer.

An electronic transmission is any transmission that allows for access of electronic data, processing of electronic data, or presentation of electronic data. Such electronic transmissions optionally take the form of a Calendaring Request Message 28, Action Prompt Reminder 30, or Request Message To File (Not shown).

Registration

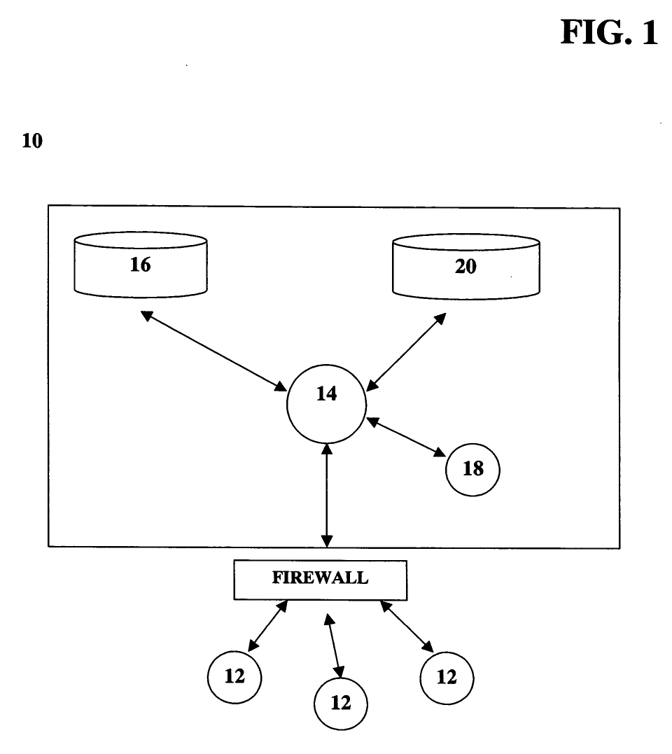

As shown in FIG. 1, a Client System preferably registers an Identifier (Not shown) with the Identicator Module 18, which is stored in the Identicator Database (Not shown). The Identifier in an embodiment is any one or combination of the following: a name, a user name-password combination, an email address, a digital certificate, a digital signature, personal identification code, membership numbers, an electronic “cookie”, or any other alpha numeric character string that would identify the Client System to the Host Server System. Preferably, at the time of registration of Client Systems, each Client System is assigned a username-password combination that is unique and exclusive to the Client System.

For purposes of this invention a Client System optionally has a multitude of users and subordinated users with various degrees of access to data residing on the Host Server System databases and functionalities of the Host Server System modules. All users and subordinated users of Client System have the ability to see all or a subset of the data of that Client System. Users or subordinated users of a second Client System are unable to see any portion of the case data of a first Client System and vice versa. For example, a first Client System comprises of the users and subordinated users of a dental office, e.g., user calendaring hygienists, subordinated user dentists, their patients/clients, and other assistants and secretaries working for a dental office. A second Client System comprises of a user sole practitioner and his/her subordinated user clients. Therefore, the users and subordinated users of the first Client System do not have access to the second Client System's case data residing on the Host Server System.

In an embodiment, a user in the Client System registers with the Host Server System 10 as a primary user. The primary user optionally gives access to, restricts access, modifies, or otherwise controls a subordinated user's accessing, processing, or presenting of case data that is stored on various Host Server System databases and functionality of various Host Server System functionalities. This is desired, for example, when the primary user is a calendaring clerk who wishes to influence or govern the calendaring activities of a dentist or a patient/client of the dentist, who as subordinated users are permitted access to, for example, view case data or obtain reports of cases only. In this embodiment of the invention, the primary user registers with the Host Server System 10 any subordinated user Identifier. The Identicator for the primary user and the subordinated user issues separate and unique Identifiers, respectively. Optionally, the user defines the subordinated user's access limits and restrictions on the use of the Host Server System. In one embodiment a subordinated user is prohibited from edit or write capabilities. In a different embodiment, a subordinate user optionally provides access to other subordinated users.

Once a user or subordinated user logs onto the Host Server System and is identified by the Identicator, the subordinated user's Identifier is forwarded to the Identicator Module 18 for identification purposes. Once the user or subordinate users of a Client System are identified, the Host Server System 10 identifies the Client Rules subset 42 within the Rule Module Database that pertains to the Client System.

In an embodiment Third Parties such as Third-Party Authorized Systems 26 register unique Identifiers with the Host Server System. Thereafter, whenever the Authorized System wishes to communicate with the Host Server System, an Identifier is presented to the Host Server System for identification purposes.

Host Server System

As seen in FIG. 1 the Host Server System 10 comprises of an Identicator Module 18, a Rules Module Database 16, a Case Listing Database 20, and Gateway Server 14. Preferably, the Host Server System further comprises of a Logging Facility 38.

Gateway Server

The Gateway Server 14 serves as an intermediary between Identicator Module 18, Case Listing Databases 20, Rules Module Database 16, and other modules and databases of Host Server System. Gateway Server is also responsible for execution of electronic commands as dictated by instructions and Action Prompts 30 and Action Prompt Due Dates in the Client Rule subset 42 of Rules Module Database 16, and routing electronic transmissions from overloaded servers on to servers that have available capacity. The Gateway Server 14 also periodically queries servers to ensure they are operative and to alert the system administrator is any server is inoperative.

Identicator Module (Identicator)

The Identicator Module 18 (Identicator) serves to identify the user or the subordinated user, and the Client System in an electronic transmission such as a Calendaring Request Message 28. The Identicator compares a user's bid Identifier with previously registered Identicator stored in the Identicator Database 36, in order to identify the user. If a bid Identifier is successfully matched against a registered Identifier, the user is positively identified.

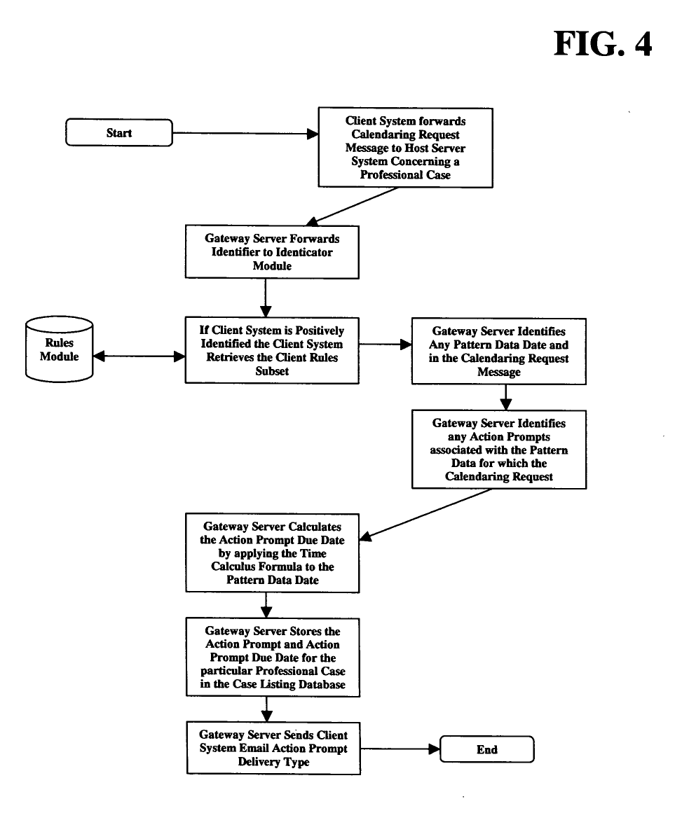

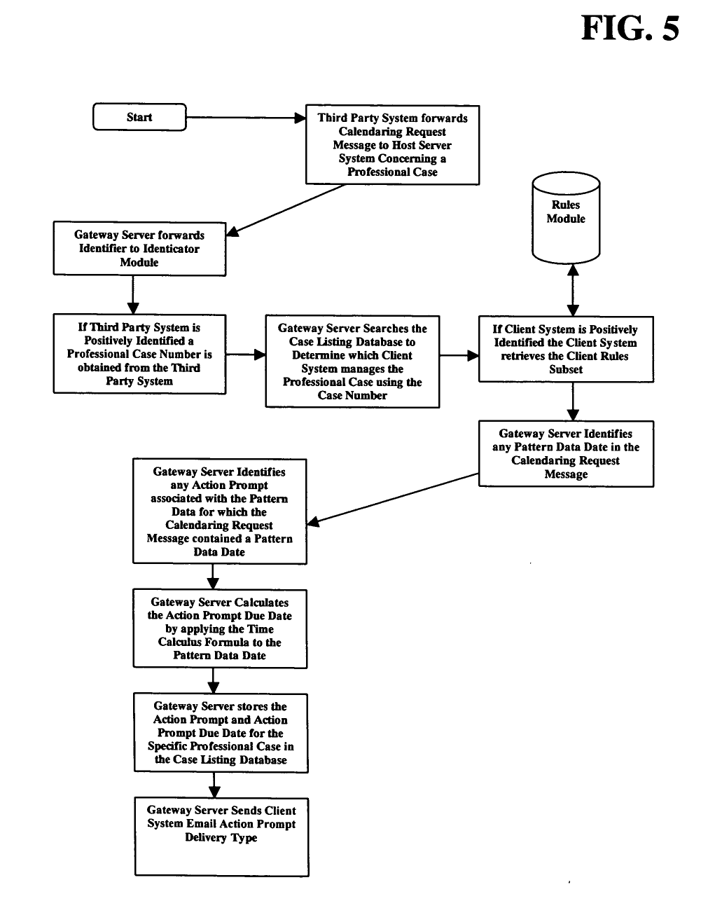

As seen in FIG. 4 and FIG. 5, the Gateway Server is responsible for overseeing the steps required to process a Calendaring Request Message 28, a Request Message to File, an Action Prompt Reminder 30, and other electronic transmissions, between the various modules and databases of the Host Server System 10.

In another embodiment, a Third-Party such as the Authorized System 26 are identified by the Identicator using any one or combination of the following electronic verification means: a Third-Party username-password combination, a digital certificate, an Internet protocol (“IP”) address, or any other code, text or number that uniquely identifies the Third-Party. In this way, the Identicator Module is able to identify the Third-Party.

In a preferred embodiment, Identicator 18 comprises of a subsystems that can identify parties from digital identification information (digital certificates). In this embodiment, the Identicator comprises of a multiple processors, each of which is capable of identifying a Third-Party from their digital certificates. Digital certificates are used to perform digital identification of a Third-Party. Where possible, computers provide digital certificates for identification of the Third-Party System.

Rules Module Database

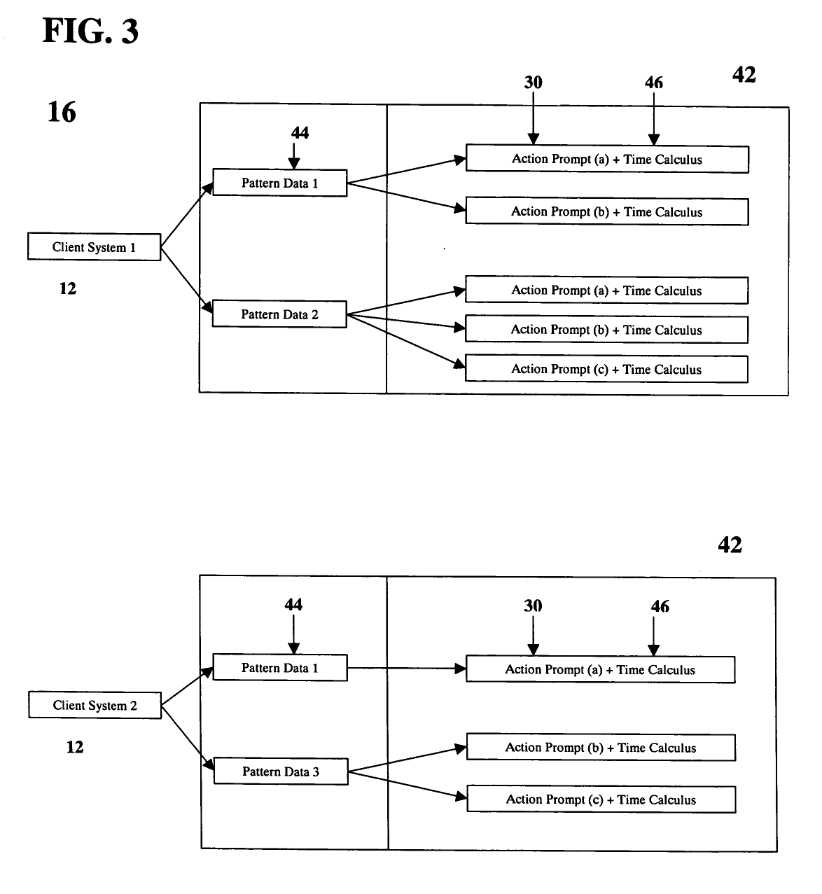

As shown in FIG. 3 the Rule Module Database 16 contains Client Rules Subset 42 for each Client System 12. Each Client Rules Subset is modifiable by the Client System and therefore customizable to the requirements of that Client System. Optionally, each user or subordinated user of the Client System 12 can define Client Rules Subset 42 to fit their unique requirements. Therefore, each Client System optionally has multiple client rules.

Regardless, each time a Client System user or subordinated user logs on, the Host Server System 10 identifies the user or subordinated user using the Identicator Module 18 and identifies the Client Rules Subset 42 for that Client System, user, or subordinated user.

As shown in FIG. 3 the Client Rules Subset contains one or more Pattern Data 44, each associated with an Action Prompt 30 and Time Calculus 46. A single Pattern Data 44 is optionally associated with more than one Action Prompt 30, thereby forming multiple Action Prompt Due Dates from a single Pattern Data. Each Action Prompt 30 have at least one Time Calculus 46 associated with it.

Pattern Data 44 is a date field such as: an appointment date field; a mail date field; payment date field; and a routine check-up date field.

An Action Prompt 30 comprises of any one or combination of the following examples: an action prompt to mail an appointment reminder; an action prompt to mail a payment reminder; an action prompt to mail a late payment reminder; and an action prompt to mail a reminder of a routine check-up.

A Time Calculus 46 comprises of any one or combination of the following; a formula for computing a date forward from a Pattern Data Date or a formula for calculating a date backwards from a Pattern Data Date.

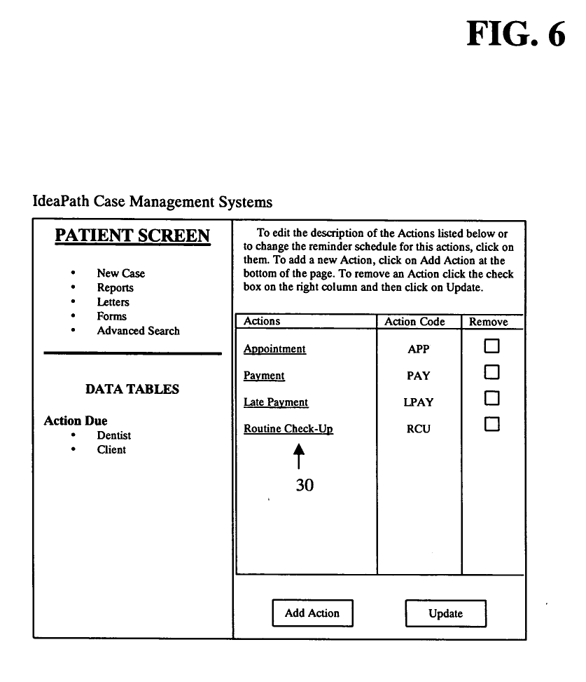

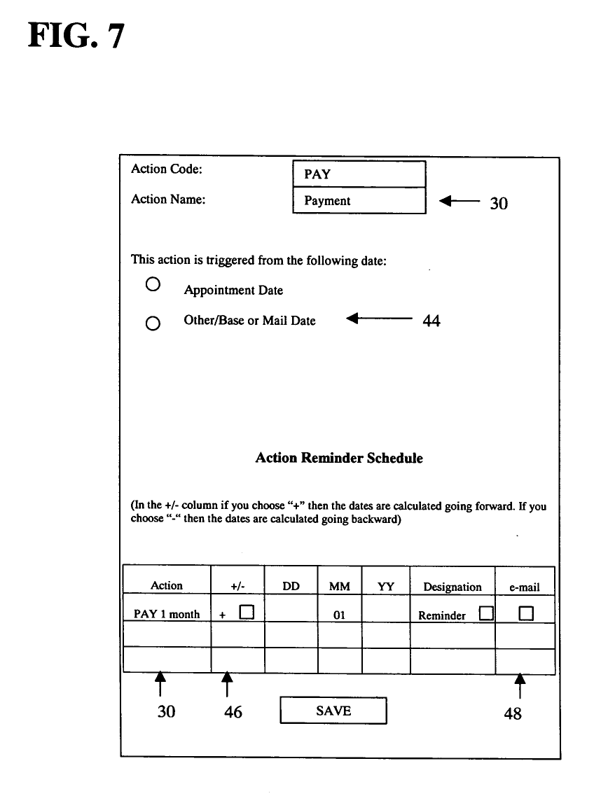

As shown in FIG. 6 in a preferred embodiment, upon registration of the Client System, the Host Server System provides the Client System with a default Client Rules Subset 42. Each default Client Rules Subset preferably has Pattern Data 44 relating to a particular date field, an Action Prompt 30 associated with the Pattern Data and a Time Calculus 46. Thereafter, as shown in FIG. 7 the Client System optionally modifies any one or combination of the Pattern Data, Action Prompt, or the Time Calculus. The Pattern Data, Action Prompt, or the Time Calculus is optionally modifiable by a Third-Party authorized by the Client System.

The Client System has the capability to delete, add or edit associations between any Pattern data 44 and any Action Prompt or to delete, add, or edit, any Time Calculus 46 associated with an Action Prompt.

In a preferred embodiment, the customizable Client Rules Subset further comprises of an Action Prompt Delivery Type 48. These comprise of an electronic mail message, a facsimile, and a printed report in response to a report request, and a display on an electronic display monitor. In an Action Prompt notification step the Client System 12 optionally transmits an electronic message to the Client System 12 or to a Third-Party authorized by the Client System. The Action Prompt Delivery Type 48 is optionally modified by the Client System or by a Third-Party authorized by the Client System.

Documents from the client rules subset 42 are prepared automatically as a result of a time criteria. The time criteria are predefined by the client system 12 in the host server system 10 as set dates. The documents are generated in response to defined search parameters. The documents are electronically forwarded to either or both the client system and Third-Party designated by the client system.

Action Prompt

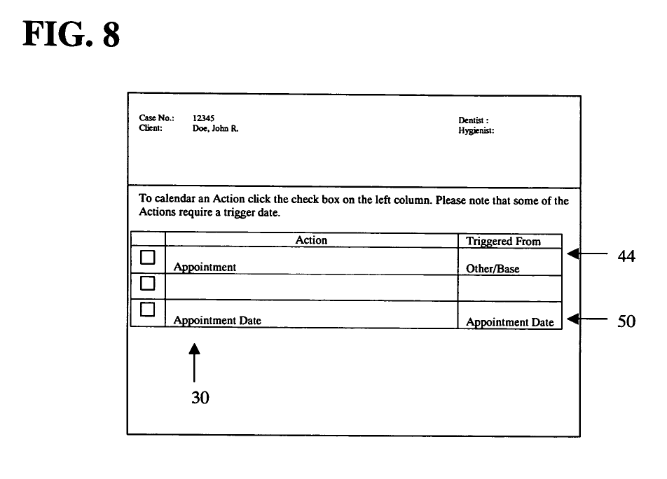

The Action Prompt 30 and Action Prompt Due Date (Not shown) provide the vehicle for notifying users of a Client System of the type of action that needs to be taken in and the time that such action should be taken, or a reminder in advance of the time an action should be taken. The Action Prompt Due Date is calculated using the Time Calculus 46 and a Pattern Data Date 50. Therefore, as shown in FIG. 6 and FIG. 8 in determining what type and what time an action needs to be taken by the Client System, the Client System submits only a Pattern Data 44, a Pattern Data date 50 and a case number which identifies the case that the Action Prompt 30 and Action Prompt Due Date should be generated for, in a Calendaring Request Message 28. Thereafter the Host Server System retrieves that Client System's Client Rules Subset. The Host Server System then identifies the Pattern Data and the Pattern Data Date in the Calendaring Request Message 28. The Host Server System determines what Action Prompts are associated with the Pattern Data submitted in the Calendaring Request Message by the Client System in the Client Rule Subset 42. For each Action Prompt associated with the Pattern Data submitted in the Calendaring Request Message, the Host Server System computes the Action prompt Due Date by applying the formula of the Time Calculus 46 to the Pattern Data Date provided in the Calendaring Request Message. Therefore, the Host Server System generates the Action Prompt (what action needs to be taken by the Client System) and the Action Prompt Due Date (the time an action needs to be taken by the Client System) only from a Pattern Data and Pattern Data Date in the Calendaring Request Message. In a preferred embodiment, the Host Server System then determines if the Client System 12 has selected an Action Prompt Delivery Type 48. If the Client has chosen an Action Prompt Delivery Type of an electronic mail message, then the Gateway Server causes an electronic mail message to be sent to an electronic mail list identified for the case by the Client System notifying them of the Action Prompt and the Action Prompt Due Date. In an embodiment, if no Action Prompt Delivery Type has been designated, then the Host Server System saves the Action Prompt and the Action Prompt Due Date in the Case Listing Database 20 for future retrieval by the Client System. The retrieval of the Action Prompt and Action Prompt Due Date is optionally either through a report generated for Action Prompts and Action Prompt Due Dates, or through a search of a specific case in the Case Listing Database.

Optionally, the method of the invention includes the Host Server System performing a date conflict check step wherein the Client System is notified if two Action Prompt Due Dates fall on the same date.

As defined herein, a customized Client Rules Subset 42 does not necessarily have Pattern Data 44, Action Prompt 30, or Time Calculus 46 that is unique to a Client System, but rather that they are indexed to or are associated with a specific Client System or Client System user or subordinated user. As such, the same Pattern Data 44 or Action Prompt 30 is optionally assigned to several Client Systems, and hence would not be unique to any one Client System.

Automated Calendaring System

As shown in FIG. 5 in one embodiment, a Calendaring Request Message 28 is forwarded from the Third-Party System 26 to the Host Server System 10. The Calendaring request Message comprises of a Third-Party System Identifier (Not shown), Pattern Data 44, and Pattern Data Date for a case identified by a case number. Preferably, the Calendaring Request Message also includes a Client System Identifier 34. The Identicator Module 18 identifies the Third-Party System using the Third-Party Identifier, identifies the case in the Case Listing Database using the case number, and identifies the Client Rules Subset 42 in the Case Listing Database 20 for the Client System that manages the particular case that the Third-Party System submitted a Calendaring Request Message for. The Gateway Server 14 then identifies the Pattern Data and the Pattern Data Date in the Calendaring Request Message 28 forwarded by the Third-Party System. From the Pattern Data in the Calendaring Request Message, the Host Server System determines the Action Prompts that are associated with the Pattern Data from the Client Rule Subset 42. For each Action Prompt the Host Server System computes the Action prompt Due Date by applying the formula of the Time Calculus to the date provided in the Calendaring Request Message. Therefore, the Host Server System derives the Action Prompt (what action needs to be taken by the Client System) and the Action Prompt Due Date (the time an action needs to be taken by the Client System) only from the Pattern Data and Pattern Data Date in the Calendaring Request Message. In a preferred embodiment the Host Server System then determines if the Client System 12 has selected an Action Prompt Delivery Type 48. If the Client has chosen an Action Prompt Delivery Type that includes an electronic mail message system, then the Host Server System causes an electronic mail message to be sent to an electronic mail list identified for the case by the Client System notifying them of the Action Prompt and the Action Prompt Due Date. If no Action Prompt Delivery Type has been designated, then the Host Server System saves the Action Prompt and the Action Prompt Due Date in the Case Listing Database 20 for future retrieval by the Client System.

Optionally, the Third-Party System appends an electronic document, in ASCII, Word Perfect, MSWord, GIF, JPG, PDF, or any other type of format to the Calendaring Request Message.

The Action Prompt notification step and retrieval of the Action Prompt and Action Prompt Due Date has been described earlier. In this manner, the Host Server System 10 automatically calendars Action Prompts and Action Prompt Due Dates for a case without the manual re-entry of Pattern Data and Pattern Data dates into a Professional Calendaring System.

In a different embodiment, the Host Server System registers with the Third-Party System 26 and submits an Identifier to the Third-Party System. In this embodiment, the Gateway Server 14 of the Host Server System queries the databases of the Third-Party System for particular cases using case numbers such as those generally assigned to a case by the Third-Party System. Preferably, in confidential cases, the Host Server System obtains an Authorization Code form the Client System, wherein the Authorization Code is recognized by the Third-Party System as authorization given by the Client System to the Host Server System for querying the Third-Party System databases for data regarding a client system case.

An Authorization Code comprises of any one or combination of the following; a Client System name, a Client System code, a user name-password combination, an email address, a digital certificate, a digital signature, personal identification code, membership numbers, an electronic “cookie”, or any other alpha numeric character string that would indicate to the Third-Party System that the Host Server System is authorized to query the Third-Party System databases for the status, Pattern Data, Pattern Data Dates, or any other data of a case.

Once the Host Server System obtains Pattern Data and Pattern Data Dates for a particular case identified by a case number from the Third Party Systems, the Host Server System identifies the Client System that manages the case using case numbers such as those generally assigned to the case, and proceeds to calendar any necessary Action Prompts and Action Prompt Due dates as described above.

Automated Document Generation and Filing System

In a preferred embodiment, the Host Server System further comprises of a document generation step wherein any one or combination of the following documents are created by the host server system using information contained in the Case Listing Database 20; documents, action prompt reports, action prompt due date reports, client system defined forms, and client system defined letters. In an embodiment the documents are prepared automatically as a result of a time criteria. The time criteria are optionally defined by the client system in the host server system and optionally include a set date.

In an embodiment, the document generated automatically is in response to defined search parameters, wherein the search parameters are selected.

In a preferred embodiment, whether the document is automatically generated or not, it is automatically electronically forwarded to any one or both of the following; the client system or Third-Party Authorized Systems 26 as instructed by the Client System.

Example of a Case Transfer from One Professional in a Specific Field to Another Professional in the Same Field

In this example a professional is a user of the first Client System. The first Client System is registered with the Host Server System and the professional has read and edit authorization. The case of a client of the professional is contained in the Case Listing Database and Action Prompts 30 and the Gateway Server 14 as per the Client Rules Subset 42 of the first Client System generates Action Prompt Due Dates. Thereafter, the case is transferred from the first Client System to a second Client System by instructions of the client. If the Second Client System is registered with the Host Server System, preferably by authorization of the client, the administrator of the Host Server System, edits the case data for the transferred case to indicate that the second Client System 12, with a new professional, a new address, a new email address, or any other new data, has been designated in charge of the case in the Host Server System's database, and stores the specific case under the second Client System cases in the Case Listing Database 20.

Preferably, from then on the second Client System 12 receives Action Prompts 30 and Action Prompt Due Dates, using Action Prompt Delivery Types 48 specified by the second Client System. In this manner, calendaring has been accomplished according to the reminder schedules and terminology of the second Client System without manual entry of substantially identical data and without delay.

If the second Client System is not registered with the Host Server System, preferably they register with the Host Server System and specify their preferences for Action Prompts, Action Prompt Due Dates, Time Calculus 46, and Action Prompt Delivery Type 48 in the Client Rules Subset. Once the second Client System is registered, the administrator of the Host Server System transfers the case to the second Client System as specified above.

From the foregoing, it will be appreciated how the objectives and features of the above-described invention are met.

First, the invention provides a computer based electronic calendaring system that eliminates the need for users in a client system, to manually re-enter calendaring information regarding a case into a calendaring system., Second, this invention provides the ability for the calendaring system to interface with a Third-Party server and database such as a Third-Party System to automatically calendar action prompts and action prompt due dates without the need to manually enter the calendaring information or data regarding a case into a calendaring system.

Third, the invention provides a system for ensuring that users have the portability and mobility to gain immediate access to their calendaring information via the Internet.

Fourth, this invention provides a user-customized client rules subset wherein user client systems can choose their action prompts, the due date schedule for action prompts, and multiple action prompts for particular tasks that have to be performed.

Fifth, this invention enables primary users to both register and govern the calendaring activities of subordinated users.

Sixth, the invention provides a cost-effective computerized electronic transmissions system that is practical, convenient, and easy use.

Although the invention has been described with respect to a particular computer based calendaring system having a customizable client rules subset and the method for its use, it will be appreciated that various modifications of the apparatus and method are possible without departing from the invention, which is defined by the claims set forth below.

1. A computer based method for calendaring an event using an electronic customizable client rules subset, said method comprising the steps of:
a. under control of a client system,
i. sending a calendaring request message to a host server system at a first uniform resource locator, the host server system having a client case listing database containing case information from at least two client systems,
ii. the calendaring request message further comprising pattern data and a pattern data date,
b. under control of the host server system,
i. receiving the calendaring request message,
ii. identifying the client system using a client system identifier,
iii. identifying the customizable client rules subset in a rule module database associated with the identified client system, wherein the host server system has a customizable client rule subset from at least two client systems,
iv. using the pattern data contained in the calendaring request message selecting at least one associated action prompt from the customizable client rules subset,
v. computing an action prompt due date for each of the associated action prompts using the pattern data date and a time calculus, and recording the action prompt and computed action prompt due date for the case selected by the client system.

2. The method of claim 1 wherein the customizable client rules subset comprises of a client system client rules subset identifier, at least one pattern data, at least one action prompt associated with the pattern data, and at least one time calculus associated with the client system action prompt.

3. The method of claim 1 wherein the time calculus is modifiable by any one or both of the following; by the client system and by a Third-Party authorized by the client system.

4. The method of claim 1 wherein the action prompt is modifiable by any one or both of the following; by the client system and by a Third-Party authorized by the client system.

5. The method of claim 1 wherein the client rules subset further comprises of at least one action prompt delivery type.

6. The method of claim 5 further comprising an action prompt delivery type notification step selected from one or more of the following; an electronic mail message, a facsimile message, a printed report in response to a report request, and a display on an electronic display monitor.

7. The method of claim 5 wherein the client system defined action prompt delivery type is modifiable by any one or both of the following; by the Client System and by a Third-Party System authorized by the Client System.

8. The method of claim 1 further comprising a document generation step wherein any one or combination of the following documents are created by the host server system using information contained in the case listing database; professional documents, action prompt reports, action prompt due date reports, client system defined forms, and client system defined letters.

9. The method of claim 8 wherein the documents are prepared automatically as a result of a time criteria.

10. The method of claim 8 wherein the time criteria is defined by the client system in the host server system.

11. The method of claim 8 wherein the time criteria is a set date.

12. The method of claim 8 wherein the document is generated in response to defined search parameters.

13. The method of claim 8 wherein the document is electronically forwarded to any one or both of the following; the client system and Third-Party System designated by the client system.

14. The method of claim 1 wherein pattern data comprises of any one or combination of the following: an appointment date field; a mail date field; payment date field; and a routine check-up date field.

15. The method of claim 14 wherein any professional can conform the pattern data in accordance to their profession.

16. The method of claim 1 wherein the action prompt comprises of any one or combination of the following examples: an action prompt to mail an appointment reminder; an action prompt to mail a payment reminder; an action prompt to mail a late payment reminder; and an action prompt to mail a reminder of a routine check-up.

17. The method of claim 1 wherein the time calculus comprises of any one or both of the following; a formula for computing a date forward from a base date and a formula for calculating a date backwards from a base date.

18. The method of claim 1 further comprising a date conflict check step wherein the client system is notified if two action prompt due dates fall on the same date.

19. The method of claim 1 wherein the identifier is any one or combination of the following: a user name, a password, an email address, a digital certificate, a digital signature, personal identification code, membership numbers, an electronic “cookie”, any other alpha numeric character string that would identify the client system to the host server system.

20. A computer based system for on-line calendaring using an electronic customizable client rules subset, said system comprising:
a. at least two client systems, each client system identified by a unique uniform resource locator;
b. the host server system identified by a uniform resource locator further comprising;
i. at least two customizable client rules subsets from at least two client systems, the client rules subset further comprising pattern data, and at least one action prompt associated with the pattern data,
ii. an identicator for identifying the client system, and the client rules subset, and
iii. a client case listing database containing case information from at least two client systems.

21. The system of claim 20 wherein the customizable client rules subset comprises of a client system rule module identifier, client system defined pattern data associated with the client system rule module identifier, a client system defined action prompt associated with the client system pattern data, and a client system defined time calculus associated with the client system action prompt.

22. The system of claim 20 wherein the action prompt is modifiable by any one or both of the following: by the client system and by a Third-Party authorized by the client system.

23. The system of claim 20 wherein the customizable client rules subset further comprises of an action prompt delivery type.

24. The system of claim 23 wherein an action prompt delivery type is selected from one or more of the following; an electronic mail message, a printed report in response to a report request, and a display on an electronic display monitor.

25. The system of claim 23 wherein the action prompt delivery type is modifiable by any one or both of the following: by the client system and by a Third-Party authorized by the client system.

26. The system of claim 20 wherein the documents are prepared automatically as a result of a time criteria.

27. The system of claim 26 wherein the time criteria is predefined by the client system in the host server system.

28. The system of claim 26 wherein the time criteria is a set date.

29. The system of claim 26 wherein the documents are generated in response to defined search parameters.

30. The system of claim 26 wherein the documents are electronically forwarded to any one or both of the following; the client system and Third-Party designated by the client system.

31. The system of claim 20 wherein the action prompt comprises of any one or combination of the following examples: an action prompt to mail an appointment reminder; an action prompt to mail a payment reminder; an action prompt to mail a late payment reminder; and an action prompt to mail a reminder of a routine check-up.
